(19) United States
(12) Patent Application Publication
(10) Pub. No.: US 2025/0174840 A1
(43) Pub. Date: May 29, 2025

(54) BUSBAR MODULE

(71) Applicant: YAZAKI CORPORATION, Tokyo (JP)

(72) Inventors: Hirotaka Mukasa, Makinohara-shi (JP); Tatsuya Oga, Makinohara-shi (JP); Yoshiki Aoshima, Makinohara-shi (JP)

(21) Appl. No.: 19/041,983

(22) Filed: Jan. 30, 2025

Related U.S. Application Data
(63) Continuation of application No. PCT/JP2023/041360, filed on Nov. 16, 2023.

(30) Foreign Application Priority Data
Nov. 30, 2022 (JP) 2022-192294

(51) Int. Cl. H01M 50/519; H01M 50/503; H01M 50/507

(52) U.S. Cl. CPC H01M 50/519; H01M 50/503; H01M 50/507

(57) ABSTRACT

A busbar module to be attached to a battery assembly includes: a first circuit body having a first wiring pattern; a second circuit body having a second wiring pattern; and an electronic component attached to first and second branch line portions to connect the first and second wiring patterns and busbars. The first and second wiring patterns are electrically connected at an overlapping portion of first and second main line portions. The busbar module further includes a waterproof portion that seals the overlapping portion in a watertight manner.

### CROSS-REFERENCE TO RELATED APPLICATIONS

This is a continuation of International Application No. PCT/JP2023/041360 filed on Nov. 16, 2023, and claims priority from Japanese Patent Application No. 2022-192294 filed on Nov. 30, 2022, the entire content of which is incorporated herein by reference.

### TECHNICAL FIELD

The present disclosure relates to a busbar module.

### BACKGROUND ART

In the related art, a busbar module is used, for example, by being assembled to a battery assembly (that is, a battery module in which a plurality of battery cells are stacked and arranged) that is used as a driving power source mounted on an electric vehicle, a hybrid vehicle, or the like as disclosed in, for example, JP2014-220128A.

The busbar module described in JP2014-220128A includes a plurality of busbars that are stacked and connect a positive electrode and a negative electrode between adjacent battery cells, and a voltage detection line that is connected to the plurality of busbars and monitors the battery cells. The voltage detection line is configured to bundle a plurality of electric wires having a general structure in which a core wire is covered with an insulating sheath.

In general, the battery cells forming the battery assembly expand and contract in a stacking direction due to operating heat accompanying charging and discharging, a temperature of an external environment, and the like. As a result, the battery assembly (battery module) is also deformed to expand and contract in the stacking direction of the battery cells. Further, a size of the battery assembly in the stacking direction may generally vary for each manufactured battery assembly (that is, a manufacturing variation may occur) due to an assembly tolerance when the plurality of battery cells are stacked and arranged. Therefore, the busbar module is generally designed to have a certain margin in a length of the voltage detection line in order to cope with such deformation and manufacturing variation of the battery assembly.

However, in the above busbar module of the related art, for example, when the number of stacked battery cells is increased for the purpose of increasing the capacity of the battery assembly, the number of electric wires forming the voltage detection line also increases. As a result, when a plurality of electric wires are bundled together to form the voltage detection line, the rigidity of the voltage detection line as a whole (and thus the rigidity of the busbar module) increases, and this may make it difficult to improve the workability (ease of assembly) of assembling the busbar module to the battery assembly. For the same reason, it may also become difficult for the busbar module to expand and contract sufficiently to cope with the deformation and the manufacturing variation of the battery assembly.

An object of the present disclosure is to provide a busbar module that is easy to assemble to a battery assembly and has excellent adaptability to deformation and a manufacturing variation of the battery assembly.

### SUMMARY OF INVENTION

In order to achieve the above object, a busbar module according to an embodiment of the present disclosure is a busbar module to be attached to a battery assembly in which a plurality of single cells are stacked, the busbar module including:
a first circuit body that is formed of a flexible substrate having a first wiring pattern and that includes a first main line portion and a first branch line portion, the first main line portion extending along a stacking direction of the plurality of single cells, and the first branch line portion extending to branch from the first main line portion;
a second circuit body that is formed of a flexible substrate having a second wiring pattern and that includes a second main line portion and a second branch line portion, the second main line portion extending along the stacking direction, and the second branch line portion extending to branch from the second main line portion;
busbars each of which is connected to an electrode of the plurality of single cells;
an electronic component that is attached to the first branch line portion and the second branch line portion such that the first wiring pattern and the second wiring pattern are connected to the corresponding busbars; and
a holder that is extensible and contractible along the stacking direction and is configured to hold the first circuit body, the second circuit body, and the busbars, in which
the first wiring pattern includes a plurality of first contact portions arranged in the stacking direction,
the second wiring pattern includes a plurality of second contact portions arranged in the stacking direction,
the plurality of first contact portions and the plurality of second contact portions are respectively and electrically connected at an overlapping portion of the first main line portion and the second main line portion, and
a waterproof portion that seals the overlapping portion in a watertight manner is further provided.

### ADVANTAGEOUS EFFECTS OF INVENTION

According to the busbar module of one embodiment of the present disclosure, the first circuit body and the second circuit body (hereinafter also referred to as “main lines”) formed of the flexible substrates are integrated by electrically connecting the first contact portion of the first wiring pattern and the second contact portion of the second wiring pattern at the overlapping portion of the first main line portion of the first circuit body and of the second main line portion of the second circuit body. In other words, the first circuit body and the second circuit body are electrically connected to each other. The first branch line portion and the second branch line portion (hereinafter also referred to as “branch lines”) extend to branch from the first main line portion and the second main line portion, respectively. Therefore, when the battery assembly expands and contracts in the stacking direction due to the thermal deformation of each of the single cells, each of the busbars can move in the stacking direction of the single cells by bending the branch line or the like. Similarly, by the bending the branch line or the like, the variation in the size of the battery assembly in the stacking direction due to the assembly tolerance of the single cells can be absorbed. In other words, the busbar module having the present configuration can easily cope with the extension and contraction and the manufacturing variation of the battery assembly by deforming the branch line. Here, in general, even when the flexible substrate includes a large number of circuit structures, the flexible substrate is easily and flexibly deformed with a much smaller force than an electric wire used in the busbar module in the related art described above. Therefore, the ease of assembly into the battery assembly is improved. Accordingly, the busbar module having the present configuration can be easily assembled to the battery assembly and has more excellent adaptability to the deformation and the manufacturing variation of the battery assembly than the busbar module in the related art described above.

According to the busbar module having the above configuration, the first circuit body and the second circuit body are prepared as separate bodies and then electrically connected to each other. Therefore, compared to a case in which the first circuit body and the second circuit body are formed of a single continuous flexible substrate, a length of each of the first circuit body and the second circuit body in the stacking direction is shortened. Therefore, a dedicated large-sized mounting device is not required when the electronic components are attached (that is, mounted) to the first branch line portion and the second branch line portion. In other words, even when the length or the size of the final main line obtained by connecting the first circuit body and the second circuit body is not suitable for a general (general-purpose) mounting device, the first circuit body and the second circuit body may be connected to each other after the electronic component is appropriately mounted on the branch circuit body using the general (general-purpose) mounting device for each of the first circuit body and the second circuit body. Therefore, the manufacturing cost of the busbar module can be reduced.

According to the busbar module having the above configuration, since the first circuit body and the second circuit body are prepared as separate bodies and then electrically connected to each other, when the busbar module is exposed to water or the like, liquid such as the water may enter the overlapping portion of the first main line portion of the first circuit body and the second main line portion of the second circuit body (between the first main line portion and the second main line portion). However, since the busbar module includes the waterproof portion that seals the overlapping portion in a watertight manner, it is possible to prevent occurrence of a problem in which the adjacent connection portions are conducted (short-circuited) through liquid.

### BRIEF DESCRIPTION OF DRAWINGS

FIG. 1 is a perspective view showing a busbar module according to a first embodiment of the present disclosure.

FIG. 2 is a perspective view showing a battery assembly to which the busbar module shown in FIG. 1 is to be assembled.

FIG. 3 is a perspective view illustrating a procedure when a first circuit body and a second circuit body forming a circuit body shown in FIG. 1 are connected and accommodated in a holder.

FIG. 4 is a perspective view showing a state in which the first circuit body and the second circuit body shown in FIG. 3 are connected and accommodated in the holder.

FIG. 5 is a top view of a portion where connection portions of the first circuit body and the second circuit body shown in FIG. 4 are connected to each other (the holder is not shown).

FIG. 6 is a perspective view showing a busbar module according to a second embodiment of the present disclosure.

FIG. 7 is a perspective view showing a battery assembly to which the busbar module shown in FIG. 6 is to be assembled.

FIG. 8 is a perspective view illustrating a procedure when a first circuit body and a second circuit body forming a circuit body shown in FIG. 6 are connected and accommodated in a holder.

FIG. 9 is a perspective view showing a state in which the first circuit body and the second circuit body shown in FIG. 8 are connected and accommodated in the holder.

FIG. 10 is a top view of a portion where connection portions of the first circuit body and the second circuit body shown in FIG. 9 are connected to each other (the holder is not shown).

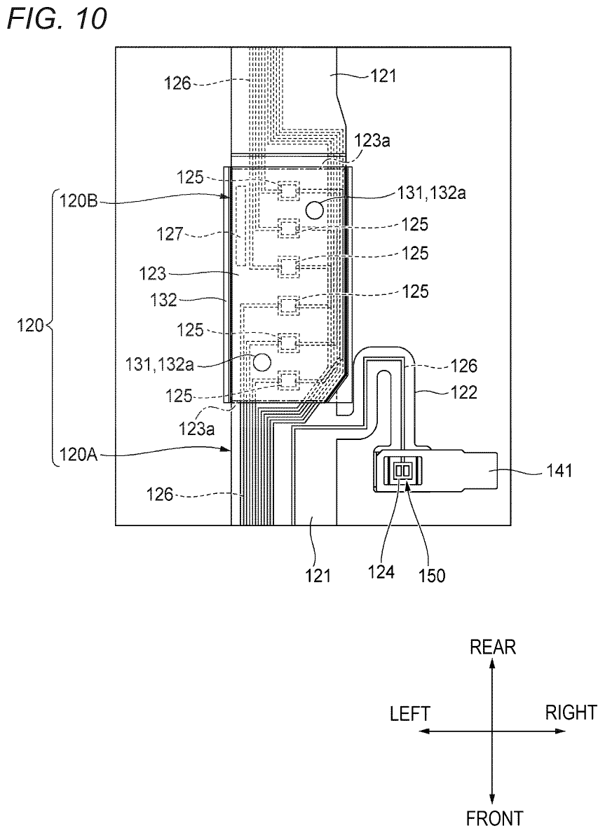

### DESCRIPTION OF EMBODIMENTS

### <First Embodiment>

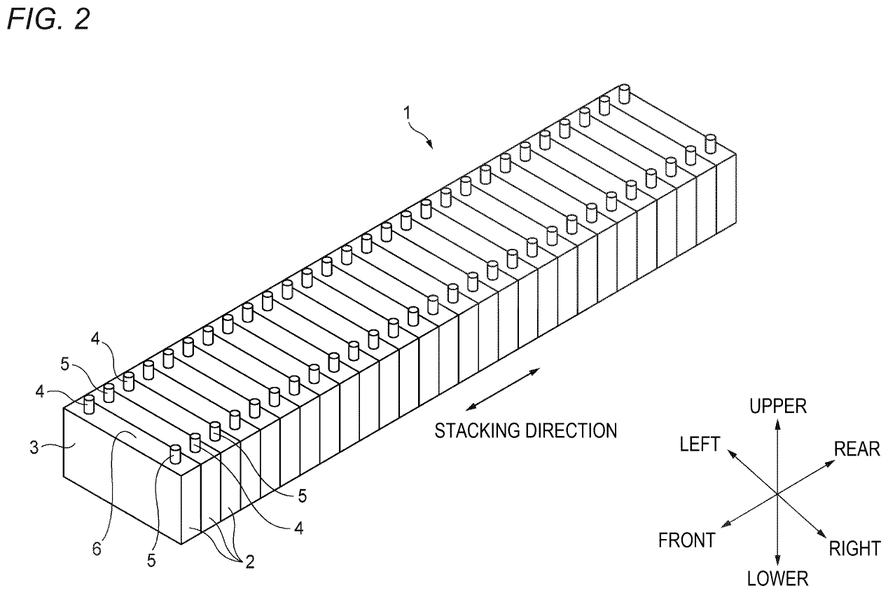

Hereinafter, a busbar module 10 according to a first embodiment of the present disclosure will be described with reference to the drawings. The busbar module 10 according to the present embodiment is used, for example, by being assembled to a long battery assembly 1 (see FIG. 2. a battery module in which a plurality of single cells are stacked and arranged) that is used as a driving power source mounted on an electric vehicle. 20

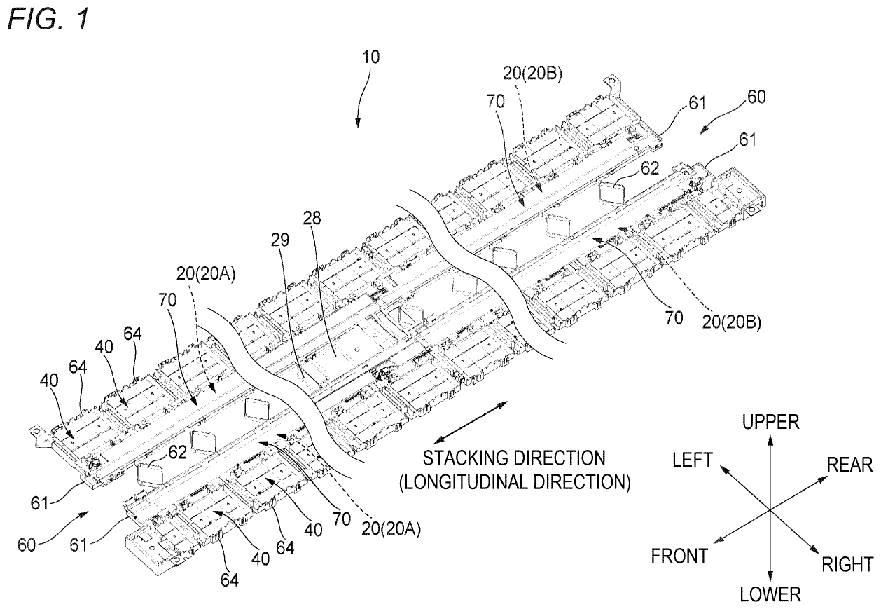

Hereinafter, for convenience of description, “front”, “rear”, “left”, “right”, “upper”, and “lower” are defined as shown in FIG. 1 or the like. A “front-rear direction”, a “left-right direction”, and an “upper-lower direction” are orthogonal to one another. The front-rear direction coincides with a stacking direction (see FIGS. 1 and 2) of a plurality of single cells 2 forming the battery assembly 1. Note that these directions are defined for convenience of description, and do not necessarily correspond to the front-rear direction, the left-right direction, and the upper-lower direction of the vehicle when the busbar module 10 is mounted on a vehicle.

First, as preparation for describing the busbar module 10, the battery assembly 1 to which the busbar module 10 is attached will be described with reference to FIG. 2. As shown in FIG. 2, the battery assembly 1 is formed by stacking in the front-rear direction the plurality of rectangular flat plate-shaped single cells 2 extending in the upper-lower direction and the left-right direction. Each of the plurality of single cells 2 includes a battery body 3 having a rectangular flat plate shape, and a positive electrode 4 and a negative electrode 5 protruding upward from both end portions in the left-right direction of an upper face 6 of the battery body 3.

In the battery assembly 1, by reversing positions in the left-right direction of the positive electrodes 4 and the negative electrodes 5 of the single cells 2 adjacent to each other in the front-rear direction, the plurality of single cells 2 are stacked such that the positive electrodes 4 and the negative electrodes 5 are alternately arranged in the front-rear direction at a left end portion and a right end portion of an upper face of the battery assembly 1.

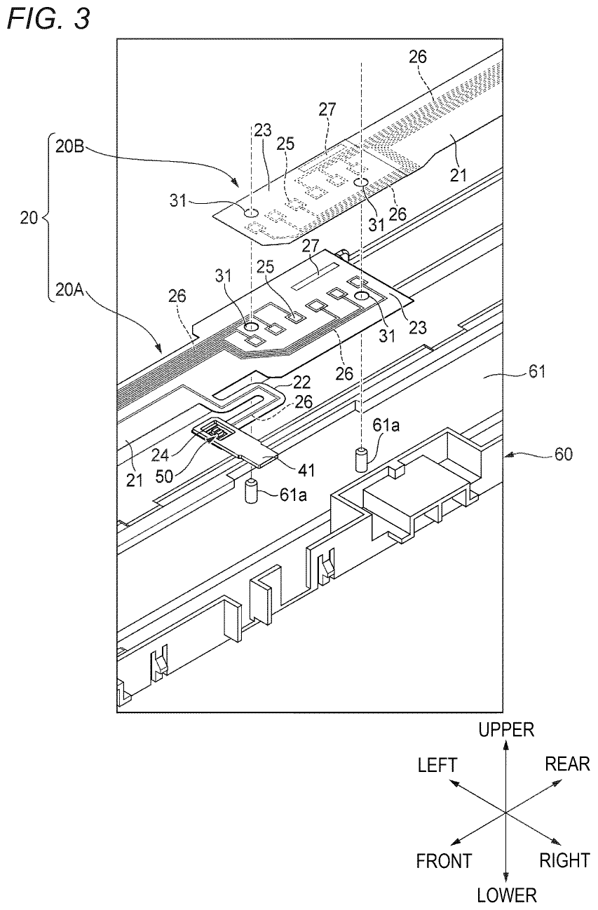

Hereinafter, the busbar module 10 will be described. As shown in FIGS. 1, 3, and 4, the busbar module 10 includes: a long circuit body 20 (see FIGS. 1 and 3) extending in the front-rear direction; a plurality of busbars 40 (see FIG. 1) connected to a plurality of branch line portions 22 (see FIG. 3) of the circuit body 20, respectively; a plurality of electronic components 50 (see FIG. 3) mounted on the plurality of branch line portions 22, respectively; a holder 60 (see FIGS. 1 and 3) holding the circuit body 20 and the busbars 40; and a cover 70 (see FIG. 1) covering the circuit body 20. A main line portion 21 and the branch line portion 22 (see FIG. 3) of the circuit body 20 are also referred to as a “main line” and a “branch line”, respectively.

The circuit body 20 is formed of an easily bendable flexible substrate (FPC). As can be understood from FIGS. 1 and 3, the circuit body 20 includes a pair of left and right first circuit bodies 20A and a pair of left and right second circuit bodies 20B. The left and right first circuit bodies 20A extend in the front-rear direction and are spaced apart in the left-right direction. The left and right second circuit bodies 20B are respectively connected to rear sides of the pair of left and right first circuit bodies 20A and extend in the front-rear direction. Either one of the pair of left and right first circuit bodies 20A and the pair of left and right second circuit bodies 20B is coupled by a coupling portion 28 (see FIG. 1) in the left-right direction. A connector 29 (see FIG. 1) electrically connected to an external voltage detection device (not shown) or the like is mounted on a lower face of the coupling portion 28.

Each of the first circuit bodies 20A and the second circuit bodies 20B includes the strip-shaped main line portion 21 extending in the front-rear direction, and at least one (in this example, a plurality of) branch line portion 22 extending from at least one (in this example, a plurality of) portion in the front-rear direction of the main line portion 21 to branch outward in the left-right direction (see FIG. 3). In this example, the branch line portion 22 extends from the main line portion 21 in a manner of having a U-shaped curved shape. Since the branch line portion 22 has a U-shaped curved shape, flexibility of the branch line portion 22 in the front-rear, left-right, and upper-lower directions is improved. A contact portion 24 made of metal is provided on an upper face of a tip end portion of the branch line portion 22 to be exposed to the outside (see FIG. 3).

By connecting a circuit connection portion 23 provided at a rear end portion of the main line portion 21 of the first circuit body 20A and a circuit connection portion 23 provided at a front end portion of the main line portion 21 of the second circuit body 20B, the main line portion 21 of the first circuit body 20A and the main line portion 21 of the second circuit body 20B are continuous with each other and extend in a row in the front-rear direction to form the circuit body 20. As shown in FIGS. 3 to 5, a size of the circuit connection portion 23 of the first circuit body 20A in a width direction (left-right direction) is larger than a size of the second circuit body 20B in the width direction. A detailed structure of the circuit connection portion 23 of each of the first circuit body 20A and the second circuit body 20B and a connection procedure between the circuit connection portions 23 will be described later.

An entire surface of each of the first circuit body 20A and the second circuit body 20B is made of a resin layer except for a portion (see FIG. 3) where the contact portion 24 provided on the branch line portion 22 is exposed and a portion (see FIG. 3) where a contact portion 25 to be described later and provided on the circuit connection portion 23 is exposed. Each of the first circuit body 20A and the second circuit body 20B includes a plurality of wiring patterns 26 therein (see FIG. 3). Each wiring pattern 26 is a copper conductor extending in a strip shape, and extends along the main line portion 21 and the branch line portion 22. Each of the first circuit body 20A and the second circuit body 20B is a so-called “single-sided flexible substrate (single-sided FPC)” having a single wiring layer. The plurality of wiring patterns 26 are arranged on the single wiring layer of each of the first circuit body 20A and the second circuit body 20B. However, each of the first circuit body 20A and the second circuit body 20B may be a “double-sided FPC”.

At a position where the circuit connection portion 23 of the first circuit body 20A and the circuit connection portion 23 of the second circuit body 20B are connected to each other, at least one (in this example, six) wiring pattern 26 belonging to the first circuit body 20A and at least one (in this example, six) wiring pattern 26 belonging to the second circuit body 20B are respectively and independently connected to each other (see FIG. 3. Details will be given later.).

Each of the plurality of wiring patterns 26 included in the first circuit body 20A and the second circuit body 20B is individually electrically connected from the contact portion 24 of the corresponding branch line portion 22 through the insides of the corresponding branch line portion 22, the main line portion 21, and the coupling portion 28, in this order, to the connector 29 mounted on the coupling portion 28. Accordingly, the contact portions 24 of the branch line portions 22 belonging to the first circuit body 20A and the second circuit body 20B are individually conductively connected to the external voltage detection device via the connector 29 mounted on the coupling portion 28.

The tip end portion of the branch line portion 22 is mounted with the electronic component 50, and is connected with an elongated flat plate-shaped metal connection terminal 41 connected to the busbar 40 (see FIG. 3 and the like). The connection terminal 41 may be a part of the busbar 40 (see FIG. 1) that is made of metal and has a substantially rectangular flat plate shape, or may be a separate member from the busbar 40 and joined to the busbar 40 by soldering or the like. The electronic component 50 is typically a chip fuse. The electronic component 50 is mounted on the tip end portion of the branch line portion 22 by soldering or the like so as to connect the contact portion 24 of the branch line portion 22 with the connection terminal 41. Accordingly, at each of the branch line portions 22, the contact portion 24 (that is, the wiring pattern 26 extending from the contact portion 24) and the connection terminal 41 (that is, the busbar 40) are electrically connected via the electronic component 50.

Such mounting of the electronic components 50 onto the branch line portions 22 is individually performed for the branch line portion 22 belonging to the first circuit body 20A and the branch line portion 22 belonging to the second circuit body 20B in a state before the circuit connection portion 23 of the first circuit body 20A and the circuit connection portion 23 of the second circuit body 20B are connected to each other (that is, in a state in which the first circuit body 20A and the second circuit body 20B are each in an independent state). Accordingly, compared to a case in which the first circuit body 20A and the second circuit body 20B are formed of a common (single) flexible substrate, a length of each of the first circuit body 20A and the second circuit body 20B in the front-rear direction is shortened, and thus a large mounting device is not required. In other words, since the first circuit body 20A and the second circuit body 20B are separate bodies, the electronic component 50 can be appropriately mounted on each branch line portion 22 regardless of a length and a size of the long circuit body 20 obtained by connecting the circuit connection portion 23 of the first circuit body 20A and the circuit connection portion 23 of the second circuit body 20B to each other, and a manufacturing cost of the busbar module 10 can be reduced.

Hereinafter, the detailed structure of the circuit connection portion 23 of the first circuit body 20A and the circuit connection portion 23 of the second circuit body 20B and the connection procedure between the circuit connection portions 23 will be described. As shown in FIG. 3, on an upper face of the circuit connection portion 23 of the first circuit body 20A, a plurality of (in this example, six) contact portions (pads) 25 made of metal are provided to be arranged in a manner of being spaced apart in the front-rear direction and to be exposed to the outside. The wiring pattern 26 extends individually from each contact portion 25. More specifically, for each of the three contact portions 25 on a front side (base end side of the circuit connection portion 23) among the six contact portions 25, the wiring pattern 26 extends from the contact portion 25 to one side (left side) in a width direction (left-right direction) of the main line portion 21 of the first circuit body 20A, and then extends forward. For each of the three contact portions 25 on a rear side (tip end side of the circuit connection portion 23) among the six contact portions 25, the wiring pattern 26 extends from the contact portion 25 to the other side (right side) in the width direction (left-right direction) of the main line portion 21 of the first circuit body 20A, and then extends forward.

In this way, by arranging extension portions of the plurality of wiring patterns 26 extending from the plurality of contact portions 25 in a distributed manner in the left-right direction, it is possible to contribute to improvement in a degree of freedom of a pattern design of the extension portions of the wiring patterns 26 extending from the contact portions 25, miniaturization of the circuit connection portion 23 (that is, the first circuit body 20A), and the like. On the upper face of the circuit connection portion 23 of the first circuit body 20A, a dummy contact portion (land) 27 made of metal is provided to be exposed to the outside at one position not interfering with the contact portions 25 and the wiring patterns 26. The dummy contact portion 27 is not connected (electrically connected) to the wiring pattern 26 (that is, the busbar 40). In the circuit connection portion 23 of the first circuit body 20A, hole portions 31 penetrating in a thickness direction (upper-lower direction) of the circuit connection portion 23 are respectively formed at a plurality of positions (in this example, two positions) not interfering with the contact portions 25, the wiring patterns 26, and the dummy contact portion 27.

On a lower face of the circuit connection portion 23 of the second circuit body 20B, a plurality of (in this example, six) contact portions (pads) 25 made of metal are provided to be arranged in a manner of being spaced apart in the front-rear direction and to be exposed to the outside, in correspondence with the plurality of contact portions 25 of the first circuit body 20A. The wiring pattern 26 extends individually from each contact portion 25. More specifically, for each of the three contact portions 25 on a front side (tip end side of the circuit connection portion 23) among the six contact portions 25, the wiring pattern 26 extends from the contact portion 25 to the other side (right side) in the width direction (left-right direction) of the main line portion 21 of the second circuit body 20B, and then extends rearward. For each of the three contact portions 25 on a rear side (base end side of the circuit connection portion 23) among the six contact portions 25, the wiring pattern 26 extends from the contact portion 25 to one side (left side) in the width direction (left-right direction) of the main line portion 21 of the second circuit body 20B, and then extends rearward.

In this way, by arranging extension portions of the plurality of wiring patterns 26 extending from the plurality of contact portions 25 in a distributed manner in the left-right direction, it is possible to contribute to improvement in a degree of freedom of a pattern design of the extension portions of the wiring patterns 26 extending from the contact portions 25, miniaturization of the circuit connection portion 23 (that is, the second circuit body 20B), and the like. On the lower face of the circuit connection portion 23 of the second circuit body 20B, a dummy contact portion (land) 27 made of metal is provided to be exposed to the outside at one position not interfering with the contact portions 25 and the wiring patterns 26, in correspondence with the dummy contact portion 27 of the first circuit body 20A. The dummy contact portion 27 is not connected (electrically connected) to the wiring pattern 26 (that is, the busbar 40). In the circuit connection portion 23 of the second circuit body 20B, hole portions 31 penetrating in the thickness direction (upper-lower direction) of the circuit connection portion 23 are respectively formed at a plurality of positions (in this example, two positions) not interfering with the contact portions 25, the wiring patterns 26, and the dummy contact portion 27, in correspondence with the plurality of hole portions 31 of the first circuit body 20A.

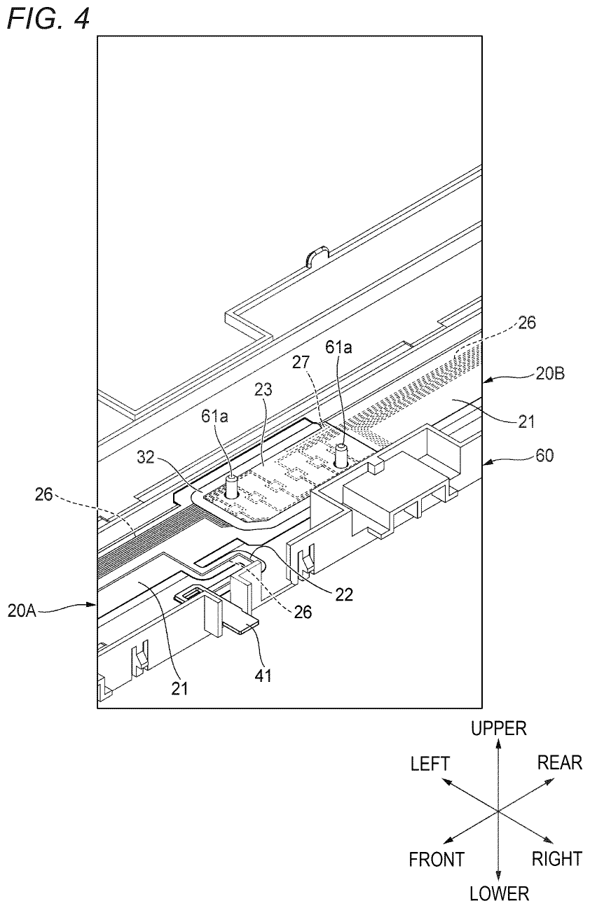

The operation of connecting the circuit connection portion 23 of the first circuit body 20A and the circuit connection portion 23 of the second circuit body 20B to each other is performed using a plurality of (in this example, two) protrusions 61a (see FIG. 3) that are provided at a plurality of (in this example, two) positions on a bottom wall of a circuit body holding portion 61 (see FIG. 3) to be described later of the holder 60, in correspondence with the plurality of hole portions 31 of the first circuit body 20A and of the second circuit body 20B. That is, first, in a state in which the circuit connection portion 23 of the first circuit body 20A is disposed below the circuit connection portion 23 of the second circuit body 20B, the plurality of protrusions 61a are inserted from below into the plurality of hole portions 31 of the first circuit body 20A and the plurality of hole portions 31 of the second circuit body 20B in this order (see FIG. 4). Accordingly, the first circuit body 20A and the second circuit body 20B are accommodated in the holder 60 (circuit body holding portion 61), and a state is obtained in which the plurality of hole portions 31 of the first circuit body 20A and the plurality of hole portions 31 of the second circuit body 20B are aligned so as to overlap each other in the upper-lower direction.

Next, the plurality of contact portions 25 of the first circuit body 20A and the plurality of contact portions 25 of the second circuit body 20B are respectively and independently soldered, and the dummy contact portion 27 of the first circuit body 20A and the dummy contact portion 27 of the second circuit body 20B are soldered together. Typically, the soldering can be performed by a method (so-called pulse heating method) of sandwiching a paste-like solder between the contact portions 25 arranged to face each other in the upper-lower direction and between the dummy contact portions 27 arranged to face each other in the upper-lower direction, then pressing, against a portion to be soldered, a heater chip that can heat the solder to a temperature at which the solder can be melted, and performing the soldering. The soldering may be performed by a reflow soldering method using a heating furnace. The electrical connection between the circuit connection portion 23 of the first circuit body 20A and the circuit connection portion 23 of the second circuit body 20B may be performed using a conductive adhesive instead of the soldering described above.

Accordingly, at positions where the circuit connection portion 23 of the first circuit body 20A and the circuit connection portion 23 of the second circuit body 20B are connected to each other, the plurality of wiring patterns 26 belonging to the first circuit body 20A and the plurality of wiring patterns 26 belonging to the second circuit body 20B are electrically connected to each other respectively and independently, and are mechanically integrated. Further, the dummy contact portion 27 of the first circuit body 20A and the dummy contact portion 27 of the second circuit body 20B are mechanically integrated with each other using a solder, a conductive adhesive, or the like. Accordingly, the first circuit body 20A and the second circuit body 20B can be more firmly integrated.

In this way, by using the hole portions 31 of the first circuit body 20A, the hole portions 31 of the second circuit body 20B, and the protrusions 61a of the holder 60, it is possible to collectively perform an operation of accommodating the first circuit body 20A and the second circuit body 20B in the holder 60 (the circuit body holding portion 61) and an operation of electrically connecting the contact portion 25 (wiring pattern 26) of the first circuit body 20A and the contact portion 25 (wiring pattern 26) of the second circuit body 20B to each other while preventing a positional deviation or the like of the contact portions 25 by the protrusions 61a. Further, when an unintended external force is applied to the circuit body 20 (more specifically, the main line portion 21 of the first circuit body 20A and the main line portion 21 of the second circuit body 20B) after the connection, the external force is received by the protrusions 61a. Therefore, it is possible to prevent the external force from being applied to a connection portion of the contact portion 25 (the wiring pattern 26) of the first circuit body 20A and the contact portion 25 (the wiring pattern 26) of the second circuit body 20B. Accordingly, the reliability of the electrical connection between the first circuit body 20A and the second circuit body 20B can be improved.

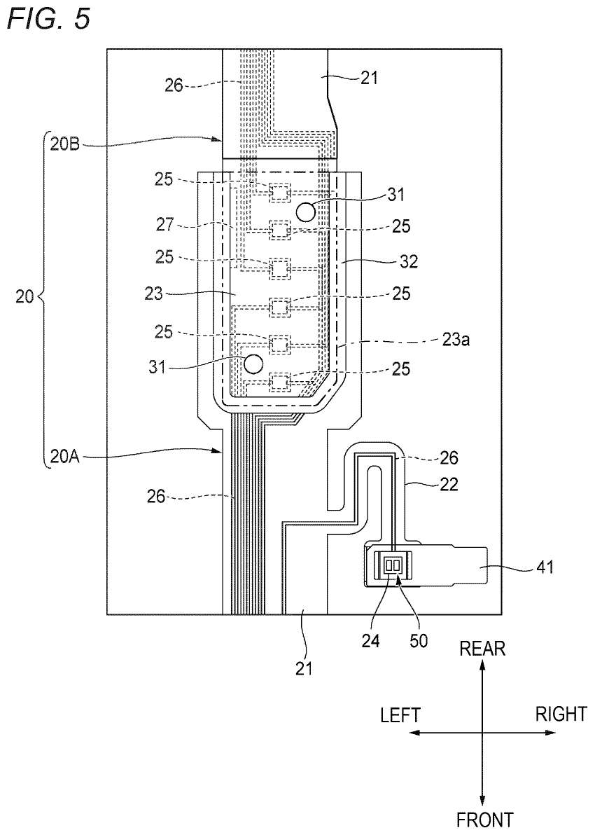

After the circuit connection portion 23 of the first circuit body 20A and the circuit connection portion 23 of the second circuit body 20B are connected to each other, a coating material 32 is applied to edge portions 23a (more specifically, three of four sides) of the circuit connection portions 23 in a substantially rectangular U-shape so as to close a gap between the circuit connection portion 23 of the first circuit body 20A and the circuit connection portion 23 of the second circuit body 20B (see FIGS. 4 and 5). This makes it possible to prevent liquids such as water from entering between the circuit connection portion 23 of the first circuit body 20A and the circuit connection portion 23 of the second circuit body 20B. That is, the coating material 32 can prevent the occurrence of a problem in which the adjacent contact portions 25 are conducted (short-circuited) through liquid. The coating material 32 is, for example, a known waterproof material or moisture-proof material.

The coating material 32 may be applied to all four sides or only one side of the edge portion 23a. Instead of the connection between the dummy contact portion 27 of the first circuit body 20A and the dummy contact portion 27 of the second circuit body 20B, the first circuit body 20A and the second circuit body 20B may be mechanically integrated with each other by the coating material 32. Note that the order of the operation of applying the coating material 32 to the edge portion 23a and the operation of accommodating the first circuit body 20A and the second circuit body 20B in the holder 60 (the circuit body holding portion 61) does not matter.

Next, the holder 60 will be described. The holder 60 is a resin molded product, and as shown in FIG. 1, integrally includes a pair of left and right strip-shaped circuit body holding portions 61 that are spaced apart in the left-right direction and extend in the front-rear direction, and a plurality of coupling portions 62 that couple the pair of left and right circuit body holding portions 61 in the left-right direction at a plurality of positions in the front-rear direction. The pair of left and right first circuit bodies 20A (main line portions 21+branch line portions 22) and the pair of left and right second circuit bodies 20B (main line portions 21+branch line portions 22) of the circuit body 20 are placed on the pair of left and right circuit body holding portions 61, correspondingly.

Specifically, each of the pair of circuit body holding portions 61 extending in the front-rear direction includes a plurality of divided bodies (not shown) arranged side by side in the front-rear direction, and extension and contraction portions (not shown) each connecting, in the front-rear direction, the divided bodies adjacent to each other in the front-rear direction.

Each of the extension and contraction portions has a shape that is easily extended and contracted in the front-rear direction due to elastic deformation. Therefore, the pair of circuit body holding portions 61 are extendable and contractible along the front-rear direction. As described above, the plurality of (two) protrusions 61a are provided on the bottom wall of the circuit body holding portion 61 (see FIG. 3).

For each of the pair of left and right circuit body holding portions 61, a busbar holding portion 64 (see FIG. 1) is integrally provided to be adjacent to an outer side in the left-right direction in each of the plurality of divided bodies arranged in the front-rear direction. That is, the plurality of busbar holding portions 64 are arranged side by side in the front-rear direction on the outer side in the left-right direction of each of the pair of left and right circuit body holding portions 61. Since each of the busbar holding portions 64 is provided in a corresponding divided body, an interval in the front-rear direction between the busbar holding portions 64 adjacent to each other in the front-rear direction can be changed by a function of the extension and contraction portion.

Each busbar holding portion 64 accommodates a corresponding busbar 40. When the holder 60 is attached to the battery assembly 1, the busbar 40 accommodated in the busbar holding portion 64 is conductively connected to the corresponding positive electrode 4 and negative electrode 5 that are adjacent to each other in the front-rear direction on the upper face of the battery assembly 1.

Next, the cover 70 will be described. The cover 70, which is a resin molded product, functions to cover the circuit bodies 20, that is, the first circuit bodies 20A (main line portions 21+branch line portions 22) and the second circuit bodies 20B (main line portions 21+branch line portions 22) placed on the pair of left and right circuit body holding portions 61 of the holder 60 which are long in the front-rear direction (see FIG. 1). Therefore, as shown in FIG. 1, the cover 70 has a strip shape formed to be long in the front-rear direction.

In an attachment completion state in which the busbar module 10 is attached to the battery assembly 1, in the battery assembly 1, the plurality of stacked single cells 2 are electrically connected in series via the plurality of busbars 40. Further, each busbar 40 is conductively connected to the external voltage detection device via the electronic component 50 mounted on the corresponding branch line portion 22, the wiring pattern 26 extending from the corresponding branch line portion 22 (contact portion 24), and the connector 29 mounted on the coupling portion 28, in this order. Accordingly, a voltage (potential) of the busbar 40 can be individually detected by the external voltage detection device. When an excessive current equal to or greater than a rated current flows in the electronic component 50 for some reason, a fuse function of the electronic component 50 causes the electronic component 50 to cut off the electrical connection between the busbar 40 and the wiring pattern 26. Accordingly, the excessive current is prevented from flowing into the voltage detection device, so that the voltage detection device can be protected.

In a use state of the battery assembly 1 to which the busbar module 10 is attached, each of the single cells 2 forming the battery assembly 1 may expand or contract in the stacking direction (the front-rear direction) due to operating heat associated with charging and discharging, a temperature of an external environment, and the like. As a result, the battery assembly 1 may deform to expand and contract in the stacking direction (front-rear direction). Further, the size of the battery assembly 1 in the stacking direction (the front-rear direction) may generally vary for each of the manufactured battery assemblies 1 due to an assembly tolerance when the plurality of single cells 2 are stacked and disposed (a manufacturing variation may occur).

In this regard, in the busbar module 10, even when the extension and contraction of the battery assembly 1 in the stacking direction (front-rear direction) due to the thermal deformation of each single cell 2 and the manufacturing variation of the battery assembly 1 occur, the extension and contraction due to the thermal deformation and the manufacturing variation of the battery assembly 1 can be easily absorbed since each of the plurality of extension and contraction portions of the holder 60 extends and contracts in the front-rear direction and each branch line portion 22 formed of the flexible substrate is easily bent.

As described above, according to the busbar module 10 of the present embodiment, the first circuit body 20A and the second circuit body 20B (main lines) formed of the flexible substrates are integrated by electrically connecting the wiring pattern 26 of the first circuit body 20A and the wiring pattern 26 of the second circuit body 20B to each other at an overlapping portion (the circuit connection portion 23) of the main line portion 21 of the first circuit body 20A and of the main line portion 21 of the second circuit body 20B. In other words, the first circuit body 20A and the second circuit body 20B are electrically connected to each other. Further, the branch line portions 22 (branch lines) extend to branch from the main line portion 21 of the first circuit body 20A and from the main line portion 21 of the second circuit body 20B. Therefore, when the battery assembly 1 expands and contracts in the stacking direction (front-rear direction) due to the thermal deformation of each of the single cells 2, each of the busbars 40 can move in the stacking direction of the single cells 2 by bending the branch line or the like. Similarly, by bending the branch line or the like, a variation in the size of the battery assembly 1 in the stacking direction (front-rear direction) due to the assembly tolerance of the single cells 2 can be absorbed. In other words, the busbar module 10 according to the present embodiment can easily cope with the expansion and contraction and the manufacturing variation of the battery assembly 1 by deforming the branch line. Here, in general, even when the flexible substrate includes a large number of circuit structures, the flexible substrate is easily and flexibly deformed with a much smaller force than an electric wire used in the busbar module in the related art described above. Therefore, the ease of assembly into the battery assembly 1 is improved. Accordingly, the busbar module 10 according to the present embodiment can be easily assembled to the battery assembly 1 and has more excellent adaptability to the deformation and the manufacturing variation of the battery assembly 1 than the busbar module in the related art described above.

Further, the first circuit body 20A and the second circuit body 20B are prepared as separate bodies and then electrically connected to each other. Therefore, compared to a case in which the first circuit body 20A and the second circuit body 20B are formed of a single continuous flexible substrate, the length of the first circuit body 20A and the second circuit body 20B in the stacking direction (front-rear direction) is shortened. Therefore, a dedicated large-sized mounting device is not required when the electronic component 50 is attached (that is, mounted) to each branch line portion 22. In other words, even when a length or a size of a final main line obtained by connecting the first circuit body 20A and the second circuit body 20B is not suitable for a general (general-purpose) mounting device, the first circuit body 20A and the second circuit body 20B may be connected to each other after the electronic component 50 is appropriately mounted on the branch line portion 22 using the general (general-purpose) mounting device for each of the first circuit body 20A and the second circuit body 20B. Therefore, the manufacturing cost of the busbar module 10 can be reduced.

According to the busbar module 10 of the present embodiment, since the first circuit body 20A and the second circuit body 20B are prepared as separate bodies and then electrically connected to each other, when the busbar module 10 is exposed to water or the like, liquid such as the water may enter the overlapping portion 23 (between the circuit connection portion 23 of the first circuit body 20A and the circuit connection portion 23 of the second circuit body) of the main line portion 21 of the first circuit body 20A and of the main line portion 21 of the second circuit body. However, since the coating material 32 is applied to the edge portions 23a of the circuit connection portions 23 of the first circuit body 20A and of the second circuit body 20B so as to close the gap between the circuit connection portion 23 of the first circuit body 20A and the circuit connection portion 23 of the second circuit body 20B, it is possible to prevent the liquid from entering the gap between the circuit connection portions 23. As a result, the occurrence of a problem in which the adjacent contact portions 25 are conducted (short-circuited) through liquid can be prevented in the busbar module 10.

### <Second Embodiment>

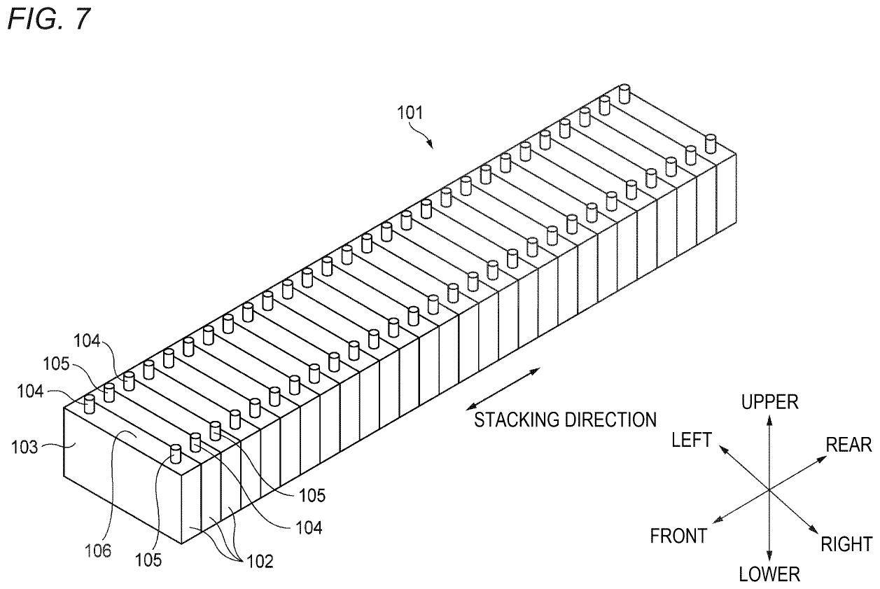

Hereinafter, a busbar module 110 according to a second embodiment of the present disclosure will be described with reference to the drawings. The busbar module 110 according to the present embodiment is used, for example, by being assembled to a long battery assembly 101 (see FIG. 7. a battery module in which a plurality of single cells are stacked and arranged) that is used as a driving power source mounted on an electric vehicle.

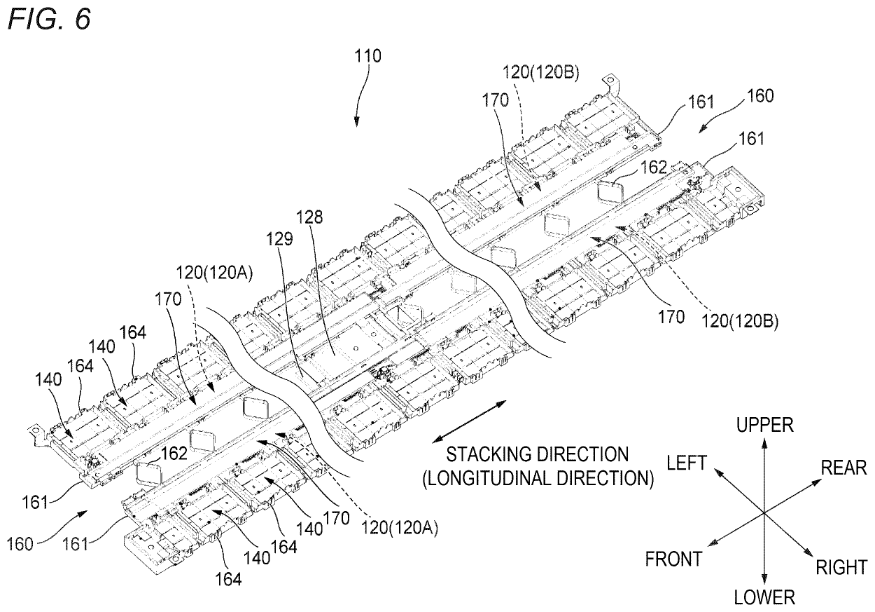

Hereinafter, for convenience of description, “front”, “rear”, “left”, “right”, “upper”, and “lower” are defined as shown in FIG. 6 or the like. A “front-rear direction”, a “left-right direction”, and an “upper-lower direction” are orthogonal to one another. The front-rear direction coincides with a stacking direction (see FIGS. 6 and 7) of a plurality of single cells 102 forming the battery assembly 101. Note that these directions are defined for convenience of description, and do not necessarily correspond to the front-rear direction, the left-right direction, and the upper-lower direction of the vehicle when the busbar module 110 is mounted on a vehicle.

First, as preparation for describing the busbar module 110, the battery assembly 101 to which the busbar module 110 is attached will be described with reference to FIG. 7. As shown in FIG. 7, the battery assembly 101 is formed by stacking in the front-rear direction the plurality of rectangular flat plate-shaped single cells 102 extending in the upper-lower direction and the left-right direction. Each of the plurality of single cells 102 includes a battery body 3 having a rectangular flat plate shape, and a positive electrode 104 and a negative electrode 105 protruding upward from both portions in the left-right direction of an upper face 106 of the battery body 103.

In the battery assembly 101, by reversing positions in the left-right direction of the positive electrodes 104 and the negative electrodes 105 of the single cells 102 adjacent to each other in the front-rear direction, the plurality of single cells 102 are stacked such that the positive electrodes 104 and the negative electrodes 105 are alternately arranged in the front-rear direction at a left end portion and a right end portion of an upper face of the battery assembly 101.

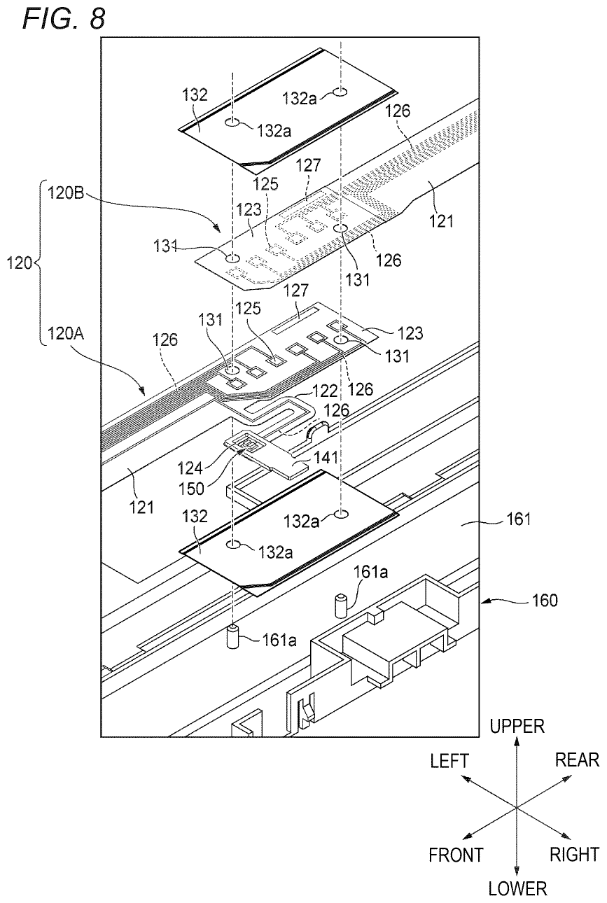

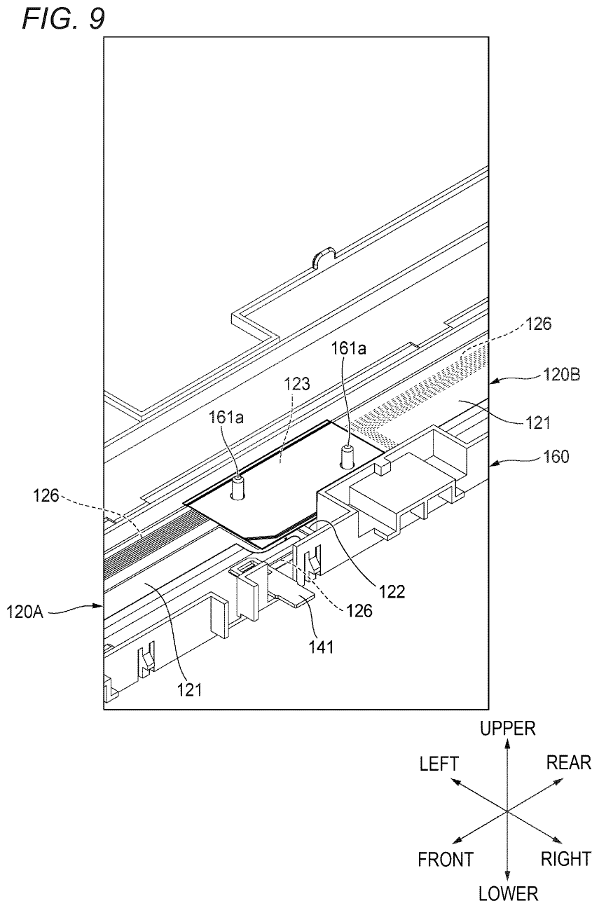

Hereinafter, the busbar module 110 will be described. As shown in FIGS. 6, 8, and 9, the busbar module 110 includes: a long circuit body 120 (see FIGS. 6 and 8) extending in the front-rear direction; a plurality of busbars 140 (see FIG. 6) connected to a plurality of branch line portions 122 (see FIG. 8) of the circuit body 120, respectively; a plurality of electronic components 150 (see FIG. 8) mounted on the plurality of branch line portions 122, respectively; a holder 160 (see FIGS. 6 and 8) holding the circuit body 120 and the busbars 140; and a cover 170 (see FIG. 6) covering the circuit body 120. A main line portion 121 and the branch line portion 122 (see FIG. 8) of the circuit body 120 are also referred to as a “main line” and a “branch line”, respectively.

The circuit body 120 is formed of an easily bendable flexible substrate (FPC). As can be understood from FIGS. 6 and 8, the circuit body 120 includes a pair of left and right first circuit bodies 120A and a pair of left and right second circuit bodies 120B. The left and right first circuit bodies 120A extend in the front-rear direction and are spaced apart in the left-right direction. The left and right second circuit bodies 120B are respectively connected to rear sides of the pair of left and right first circuit bodies 120A and extend in the front-rear direction. Either one of the pair of left and right first circuit bodies 120A and the pair of left and right second circuit bodies 120B is coupled by a coupling portion 128 (see FIG. 6) in the left-right direction. A connector 129 (see FIG. 6) electrically connected to an external voltage detection device (not shown) or the like is mounted on a lower face of the coupling portion 128.

Each of the first circuit bodies 120A and the second circuit bodies 120B includes the strip-shaped main line portion 121 extending in the front-rear direction, and at least one (in this example, a plurality of) branch line portion 122 extending from at least one (in this example, a plurality of) portion in the front-rear direction of the main line portion 121 to branch outward in the left-right direction (see FIG. 8). In this example, the branch line portion 122 extends from the main line portion 121 in a manner of having a U-shaped curved shape. Since the branch line portion 122 has a U-shaped curved shape, flexibility of the branch line portion 122 in the front-rear, left-right, and upper-lower directions is improved. A contact portion 124 made of metal is provided on an upper face of a tip end portion of the branch line portion 122 to be exposed to the outside (see FIG. 8).

By connecting a circuit connection portion 123 provided at a rear end portion of the main line portion 121 of the first circuit body 120A and a circuit connection portion 123 provided at a front end portion of the main line portion 121 of the second circuit body 120B, the main line portion 121 of the first circuit body 120A and the main line portion 121 of the second circuit body 120B are continuous with each other and extend in a row in the front-rear direction to form the circuit body 120. A detailed structure of the circuit connection portion 123 of each of the first circuit body 120A and the second circuit body 120B and a connection procedure between the circuit connection portions 123 will be described later.

An entire surface of each of the first circuit body 120A and the second circuit body 120B is made of a resin layer except for a portion (see FIG. 8) where the contact portion 124 provided on the branch line portion 122 is exposed and a portion (see FIG. 8) where a contact portion 125 to be described later and provided on the circuit connection portion 123 is exposed. Each of the first circuit body 120A and the second circuit body 120B includes a plurality of wiring patterns 126 therein (see FIG. 8). Each wiring pattern 126 is a copper conductor extending in a strip shape, and extends along the main line portion 121 and the branch line portion 122. Each of the first circuit body 120A and the second circuit body 120B is a so-called “single-sided flexible substrate (single-sided FPC)” having a single wiring layer. The plurality of wiring patterns 126 are arranged on the single wiring layer of each of the first circuit body 120A and the second circuit body 120B. However, each of the first circuit body 120A and the second circuit body 120B may be a “double-sided FPC”.

At a position where the circuit connection portion 123 of the first circuit body 120A and the circuit connection portion 123 of the second circuit body 120B are connected to each other, at least one (in this example, six) wiring pattern 26 belonging to the first circuit body 120A and at least one (in this example, six) wiring pattern 126 belonging to the second circuit body 120B are respectively and independently connected to each other (see FIG. 8. Details will be given later.).

Each of the plurality of wiring patterns 126 included in the first circuit body 120A and the second circuit body 120B is individually electrically connected from the contact portion 124 of the corresponding branch line portion 122 through the insides of the corresponding branch line portion 122, the main line portion 121, and the coupling portion 128, in this order, to the connector 129 mounted on the coupling portion 128. Accordingly, the contact portions 124 of the branch line portions 122 belonging to the first circuit body 120A and the second circuit body 120B are individually conductively connected to the external voltage detection device via the connector 129 mounted on the coupling portion 128.

The tip end portion of the branch line portion 122 is mounted with the electronic component 150, and is connected with an elongated flat plate-shaped metal connection terminal 141 connected to the busbar 140 (see FIG. 8 and the like). The connection terminal 141 may be a part of the busbar 140 (see FIG. 6) that is made of metal and has a substantially rectangular flat plate shape, or may be a separate member from the busbar 140 and joined to the busbar 140 by soldering or the like. The electronic component 150 is typically a chip fuse. The electronic component 150 is mounted on the tip end portion of the branch line portion 122 by soldering or the like so as to connect the contact portion 124 of the branch line portion 122 with the connection terminal 141. Accordingly, at each of the branch line portions 122, the contact portion 124 (that is, the wiring pattern 126 extending from the contact portion 124) and the connection terminal 141 (that is, the busbar 140) are electrically connected via the electronic component 150.

Such mounting of the electronic components 150 onto the branch line portions 122 is individually performed for the branch line portion 122 belonging to the first circuit body 120A and the branch line portion 122 belonging to the second circuit body 120B in a state before the circuit connection portion 123 of the first circuit body 120A and the circuit connection portion 123 of the second circuit body 120B are connected to each other (that is, in a state in which the first circuit body 120A and the second circuit body 120B are each in an independent state). Accordingly, compared to a case in which the first circuit body 120A and the second circuit body 120B are formed of a common (single) flexible substrate, a length of each of the first circuit body 120A and the second circuit body 120B in the front-rear direction is shortened, and thus a large mounting device is not required. In other words, since the first circuit body 120A and the second circuit body 120B are separate bodies, the electronic component 150 can be appropriately mounted on each branch line portion 122 regardless of a length and a size of the long circuit body 120 obtained by connecting the circuit connection portion 123 of the first circuit body 120A and the circuit connection portion 123 of the second circuit body 120B to each other, and a manufacturing cost of the busbar module 110 can be reduced.

Hereinafter, the detailed structure of the circuit connection portion 123 of the first circuit body 120A and the circuit connection portion 123 of the second circuit body 120B and the connection procedure between the circuit connection portions 123 will be described. As shown in FIG. 8, on an upper face of the circuit connection portion 123 of the first circuit body 120A, a plurality of (in this example, six) contact portions (pads) 125 made of metal are provided to be arranged in a manner of being spaced apart in the front-rear direction and to be exposed to the outside. The wiring pattern 126 extends individually from each contact portion 125. More specifically, for each of the three contact portions 125 on a front side (base end side of the circuit connection portion 123) among the six contact portions 125, the wiring pattern 126 extends from the contact portion 125 to one side (left side) in a width direction (left-right direction) of the main line portion 121 of the first circuit body 120A, and then extends forward. For each of the three contact portions 125 on a rear side (tip end side of the circuit connection portion 123) among the six contact portions 125, the wiring pattern 126 extends from the contact portion 125 to the other side (right side) in the width direction (left-right direction) of the main line portion 121 of the first circuit body 120A, and then extends forward.

In this way, by arranging extension portions of the plurality of wiring patterns 126 extending from the plurality of contact portions 125 in a distributed manner in the left-right direction, it is possible to contribute to improvement in a degree of freedom of a pattern design of the extension portions of the wiring patterns 126 extending from the contact portions 125, miniaturization of the circuit connection portion 123 (that is, the first circuit body 120A), and the like. On the upper face of the circuit connection portion 123 of the first circuit body 120A, a dummy contact portion (land) 127 made of metal is provided to be exposed to the outside at one position not interfering with the contact portions 125 and the wiring patterns 126. The dummy contact portion 127 is not connected (electrically connected) to the wiring pattern 126 (that is, the busbar 140). In the circuit connection portion 123 of the first circuit body 120A, hole portions 131 penetrating in a thickness direction (upper-lower direction) of the circuit connection portion 123 are respectively formed at a plurality of positions (in this example, two positions) not interfering with the contact portions 125, the wiring patterns 126, and the dummy contact portion 127.

On a lower face of the circuit connection portion 123 of the second circuit body 120B, a plurality of (in this example, six) contact portions (pads) 125 made of metal are provided to be arranged in a manner of being spaced apart in the front-rear direction and to be exposed to the outside, in correspondence with the plurality of contact portions 125 of the first circuit body 120A. The wiring pattern 126 extends individually from each contact portion 125. More specifically, for each of the three contact portions 125 on a front side (tip end side of the circuit connection portion 123) among the six contact portions 125, the wiring pattern 126 extends from the contact portion 125 to the other side (right side) in the width direction (left-right direction) of the main line portion 121 of the second circuit body 120B, and then extends rearward. For each of the three contact portions 125 on a rear side (base end side of the circuit connection portion 123) among the six contact portions 125, the wiring pattern 126 extends from the contact portion 125 to one side (left side) in the width direction (left-right direction) of the main line portion 121 of the second circuit body 120B, and then extends rearward.

In this way, by arranging extension portions of the plurality of wiring patterns 126 extending from the plurality of contact portions 125 in a distributed manner in the left-right direction, it is possible to contribute to improvement in a degree of freedom of a pattern design of the extension portions of the wiring patterns 126 extending from the contact portions 125, miniaturization of the circuit connection portion 123 (that is, the second circuit body 120B), and the like. On the lower face of the circuit connection portion 123 of the second circuit body 120B, a dummy contact portion (land) 127 made of metal is provided to be exposed to the outside at one position not interfering with the contact portions 125 and the wiring patterns 126, in correspondence with the dummy contact portion 127 of the first circuit body 120A. The dummy contact portion 127 is not connected (electrically connected) to the wiring pattern 126 (that is, the busbar 140). In the circuit connection portion 123 of the second circuit body 120B, hole portions 131 penetrating in the thickness direction (upper-lower direction) of the circuit connection portion 123 are respectively formed at a plurality of positions (in this example, two positions) not interfering with the contact portions 125, the wiring patterns 126, and the dummy contact portion 127, in correspondence with the plurality of hole portions 131 of the first circuit body 120A.

In the operation of connecting the circuit connection portion 123 of the first circuit body 120A and the circuit connection portion 123 of the second circuit body 120B, first, in a state where the circuit connection portion 123 of the first circuit body 120A is disposed below the circuit connection portion 123 of the second circuit body 120B, the plurality of contact portions 125 of the first circuit body 120A and the plurality of contact portions 125 of the second circuit body 120B are respectively and independently soldered, and the dummy contact portion 127 of the first circuit body 120A and the dummy contact portion 127 of the second circuit body 120B are soldered. Typically, the soldering can be performed by a method (so-called pulse heating method) of sandwiching a paste-like solder between the contact portions 125 arranged to face each other in the upper-lower direction and between the dummy contact portions 127 arranged to face each other in the upper-lower direction, then pressing, against a portion to be soldered, a heater chip that can heat the solder to a temperature at which the solder can be melted, and performing the soldering. The soldering may be performed by a reflow soldering method using a heating furnace. The electrical connection between the circuit connection portion 123 of the first circuit body 120A and the circuit connection portion 123 of the second circuit body 120B may be performed using a conductive adhesive instead of the soldering described above.

Accordingly, at positions where the circuit connection portion 123 of the first circuit body 120A and the circuit connection portion 123 of the second circuit body 120B are connected to each other, the plurality of wiring patterns 126 belonging to the first circuit body 120A and the plurality of wiring patterns 126 belonging to the second circuit body 120B are electrically connected to each other respectively and independently, and are mechanically integrated. Further, the dummy contact portion 127 of the first circuit body 120A and the dummy contact portion 127 of the second circuit body 120B are mechanically integrated with each other using a solder, a conductive adhesive, or the like. Accordingly, the first circuit body 120A and the second circuit body 120B can be more firmly integrated.

Next, tapes 132 are disposed below the first circuit body 120A and above the second circuit body 120B, respectively, and the tapes 132 are attached to outer surfaces of the circuit connection portions 123 so as to cover the edge portions 123a of the circuit connection portions 123 of the first circuit body 120A and of the second circuit body 120B. As a result, the gap between the circuit connection portions 123 of the first circuit body 120A and the circuit connection portions 123 of the second circuit body 120B is covered with the tapes 132, and liquids such as water can be prevented from entering between the circuit connection portion 123 of the first circuit body 120A and the circuit connection portion 123 of the second circuit body 120B. That is, the tap 132 can prevent the occurrence of a problem in which the adjacent contact portions 125 are conducted (short-circuited) through liquid. The tape 132 is, for example, a known waterproof tape or protective tape.

Next, a plurality of protrusions 161a are inserted from above through the plurality of hole portions 132a of the tape 132 on the lower side, the plurality of hole portions 131 of the first circuit body 120A, the plurality of hole portions 131 of the second circuit body 120B, and the plurality of hole portions 132a of the tape 132 on the upper side, in this order (see FIG. 8). As a result, in a state where the circuit connection portion 123 of the first circuit body 120A and the circuit connection portion 123 of the second circuit body 120B are connected to each other, the first circuit body 120A and the second circuit body 120B are accommodated in the holder 160 (the circuit body holding portion 161). When an unintended external force is applied to the circuit body 120 (more specifically, the main line portion 121 of the first circuit body 120A and the main line portion 121 of the second circuit body 120B) after the connection, the external force is received by the protrusions 161a. Therefore, it is possible to prevent the external force from being applied to a connection portion of the contact portion 125 (the wiring pattern 126) of the first circuit body 120A and the contact portion 125 (the wiring pattern 126) of the second circuit body 120B. Accordingly, the reliability of the electrical connection between the first circuit body 120A and the second circuit body 120B can be improved.

Next, the holder 160 will be described. The holder 160 is a resin molded product, and as shown in FIG. 6, integrally includes a pair of left and right strip-shaped circuit body holding portions 161 that are spaced apart in the left-right direction and extend in the front-rear direction, and a plurality of coupling portions 162 that couple the pair of left and right circuit body holding portions 161 in the left-right direction at a plurality of positions in the front-rear direction. The pair of left and right first circuit bodies 120A (main line portions 121+branch line portions 122) and the pair of left and right second circuit bodies 120B (main line portions 121+branch line portions 122) of the circuit body 120 are placed on the pair of left and right circuit body holding portions 161, correspondingly.

Specifically, each of the pair of circuit body holding portions 161 extending in the front-rear direction includes a plurality of divided bodies (not shown) arranged side by side in the front-rear direction, and extension and contraction portions (not shown) each connecting, in the front-rear direction, the divided bodies adjacent to each other in the front-rear direction. Each of the extension and contraction portions has a shape that is easily extended and contracted in the front-rear direction due to elastic deformation. Therefore, the pair of circuit body holding portions 161 are extendable and contractible along the front-rear direction. As described above, the plurality of (two) protrusions 161a are provided on the bottom wall of the circuit body holding portion 161 (see FIG. 8).

For each of the pair of left and right circuit body holding portions 161, a busbar holding portion 164 (see FIG. 6) is integrally provided to be adjacent to an outer side in the left-right direction in each of the plurality of divided bodies arranged in the front-rear direction. That is, the plurality of busbar holding portions 164 are arranged side by side in the front-rear direction on the outer side in the left-right direction of each of the pair of left and right circuit body holding portions 161. Since each of the busbar holding portions 164 is provided in a corresponding divided body, an interval in the front-rear direction between the busbar holding portions 164 adjacent to each other in the front-rear direction can be changed by a function of the extension and contraction portion.

Each busbar holding portion 164 accommodates a corresponding busbar 140. When the holder 160 is attached to the battery assembly 101, the busbar 140 accommodated in the busbar holding portion 164 is conductively connected to the corresponding positive electrode 104 and negative electrode 105 that are adjacent to each other in the front-rear direction on the upper face of the battery assembly 101.

Next, the cover 170 will be described. The cover 170, which is a resin molded product, functions to cover the circuit bodies 120, that is, the first circuit bodies 120A (main line portion 121+branch line portions 122) and the second circuit bodies 120B (main line portions 121 +branch line portions 122) placed on the pair of left and right circuit body holding portions 161 of the holder 160 which are long in the front-rear direction (see FIG. 6). Therefore, as shown in FIG. 6, the cover 170 has a strip shape formed to be long in the front-rear direction.

In an attachment completion state in which the busbar module 110 is attached to the battery assembly 101, in the battery assembly 101, the plurality of stacked single cells 102 are electrically connected in series via the plurality of busbars 140. Further, each busbar 140 is conductively connected to the external voltage detection device via the electronic component 150 mounted on the corresponding branch line portion 122, the wiring pattern 126 extending from the corresponding branch line portion 122 (contact portion 124), and the connector 129 mounted on the coupling portion 128, in this order. Accordingly, a voltage (potential) of each busbar 140 can be individually detected by the external voltage detection device. When an excessive current equal to or greater than a rated current flows in the electronic component 150 for some reason, a fuse function of the electronic component 150 causes the electronic component 150 to cut off the electrical connection between the busbar 140 and the wiring pattern 126. Accordingly, the excessive current is prevented from flowing into the voltage detection device, so that the voltage detection device can be protected.

In the use state of the battery assembly 101 to which the busbar module 110 is attached, each of the single cells 102 constituting the battery assembly 101 may expand or contract in the stacking direction (the front-rear direction) due to operating heat associated with charging and discharging, a temperature of an external environment, and the like. As a result, the battery assembly 101 may deform to expand and contract in the stacking direction (front-rear direction). Further, the size of the battery assembly 101 in the stacking direction (the front-rear direction) may generally vary for each of the manufactured battery assemblies 101 due to an assembly tolerance when the plurality of single cells 102 are stacked and disposed (a manufacturing variation may occur).

In this regard, in the busbar module 110, even when the extension and contraction of the battery assembly 101 in the stacking direction (front-rear direction) due to the thermal deformation of each single cell 102 and the manufacturing variation of the battery assembly 101 occur, the extension and contraction due to the thermal deformation and the manufacturing variation of the battery assembly 101 can be easily absorbed since each of the plurality of extension and contraction portions of the holder 160 extends and contracts in the front-rear direction and each branch line portion 122 formed of the flexible substrate is easily bent.

As described above, according to the busbar module 110 of the present embodiment, the first circuit body 120A and the second circuit body 120B (main lines) formed of the flexible substrates are integrated by electrically connecting the wiring pattern 126 of the first circuit body 120A and the wiring pattern 126 of the second circuit body 120B to each other at an overlapping portion (the circuit connection portion 123) of the main line portion 121 of the first circuit body 120A and of the main line portion 121 of the second circuit body 120B. In other words, the first circuit body 120A and the second circuit body 120B are electrically connected to each other. Further, the branch line portions 122 (branch lines) extend to branch from the main line portion 121 of the first circuit body 120A and from the main line portion 121 of the second circuit body 120B. Therefore, when the battery assembly 101 expands and contracts in the stacking direction (front-rear direction) due to the thermal deformation of each of the single cells 102, each of the busbars 140 can move in the stacking direction of the single cells 102 by bending the branch line or the like. Similarly, by bending the branch line or the like, a variation in the size of the battery assembly 101 in the stacking direction (front-rear direction) due to the assembly tolerance of the single cells 102 can be absorbed. In other words, the busbar module 110 according to the present embodiment can easily cope with the expansion and contraction and the manufacturing variation of the battery assembly 101 by deforming the branch line. Here, in general, even when the flexible substrate includes a large number of circuit structures, the flexible substrate is easily and flexibly deformed with a much smaller force than an electric wire used in the busbar module in the related art described above. Therefore, the ease of assembly into the battery assembly 101 is improved. Accordingly, the busbar module 110 according to the present embodiment can be easily assembled to the battery assembly 101 and has more excellent adaptability to the deformation and the manufacturing variation of the battery assembly 101 than the busbar module in the related art described above.

Further, the first circuit body 120A and the second circuit body 120B are prepared as separate bodies and then electrically connected to each other. Therefore, compared to a case in which the first circuit body 120A and the second circuit body 120B are formed of a single continuous flexible substrate, the length of the first circuit body 120A and the second circuit body 120B in the stacking direction (front-rear direction) is shortened. Therefore, a dedicated large-sized mounting device is not required when the electronic component 150 is attached (that is, mounted) to each branch line portion 122. In other words, even when a length or a size of a final main line obtained by connecting the first circuit body 120A and the second circuit body 120B is not suitable for a general (general-purpose) mounting device, the first circuit body 120A and the second circuit body 120B may be connected to each other after the electronic component 150 is appropriately mounted on the branch line portion 122 using the general (general-purpose) mounting device for each of the first circuit body 120A and the second circuit body 120B. Therefore, the manufacturing cost of the busbar module 110 can be reduced.

According to the busbar module 110 of the present embodiment, since the first circuit body 120A and the second circuit body 120B are prepared as separate bodies and then electrically connected to each other, when the busbar module 110 is exposed to water or the like, liquid such as the water may enter the overlapping portion 123 (between the circuit connection portion 123 of the first circuit body 120A and the circuit connection portion 123 of the second circuit body 120B) of the main line portion 121 of the first circuit body 120A and of the main line portion 121 of the second circuit body. However, the tapes 132 are attached to the outer surfaces of the first circuit body 120A and the second circuit body 120B so as to cover the edge portions 123a of the circuit connection portions 123 of the first circuit body 120A and of the second circuit body 120B, so that liquid can be prevented from entering the gap between the circuit connection portions 123. As a result, the occurrence of a problem in which the adjacent contact portions 125 are conducted (short-circuited) through liquid can be prevented in the busbar module 110.

The present disclosure has been described based on the embodiments described above, but the present disclosure is not limited to the embodiments described above, and modifications, improvements, and the like can be appropriately made. In addition, materials, shapes, sizes, numbers, arrangement positions, or the like of components in the above-described embodiments are freely selected and are not limited as long as the present disclosure can be implemented.

Here, features of the embodiment described above of the busbar module according to the present disclosure will be briefly summarized and listed in the following (i) to (iii).

(i)

A busbar module (10, 110) to be attached to a battery assembly (1, 101) in which a plurality of single cells (2) are stacked, the busbar module (10, 110) includes:
a first circuit body (20A, 120A) that is formed of a flexible substrate having a first wiring pattern (26, 126) and that includes a first main line portion (21, 121) and a first branch line portion (22, 122), the first main line portion (21, 121) extending along a stacking direction of the plurality of single cells (2, 102), and the first branch line portion (22, 122) extending to branch from the first main line portion (21, 121);
a second circuit body (20B, 120B) that is formed of a flexible substrate having a second wiring pattern (26, 126) and that includes a second main line portion (21, 121) and a second branch line portion (22, 122), the second main line portion (21, 121) extending along the stacking direction, and the second branch line portion (22, 122) extending to branch from the second main line portion (21, 121);
busbars (40, 140) each of which is connected to an electrode (4, 5, 104, 105) of the plurality of single cells (2, 102);
an electronic component (50, 150) that is attached to the first branch line portion (22, 122) and the second branch line portion (22, 122) such that the first wiring pattern (26, 126) and the second wiring pattern (26, 126) are connected to the corresponding busbars (40, 140); and
a holder (60, 160) that is extensible and contractible along the stacking direction and is configured to hold the first circuit body (20A, 120A), the second circuit body (20B, 120B), and the busbars (40, 140), in which
the first wiring pattern (26, 126) includes a plurality of first contact portions (25, 125) arranged in the stacking direction,
the second wiring pattern (26, 126) includes a plurality of second contact portions (25, 125) arranged in the stacking direction,
the plurality of first contact portions (25, 125) and the plurality of second contact portions (25, 125) are respectively and electrically connected at an overlapping portion (23, 123) of the first main line portion (21, 121) and the second main line portion (21, 121), and
a waterproof portion (coating material 32, tap 132) that seals the overlapping portion in a watertight manner is further provided.

According to the busbar module having the configuration of the above (i), the first circuit body and the second circuit body (hereinafter also referred to as “main lines”) formed of the flexible substrates are integrated by electrically connecting the first contact portion of the first wiring pattern and the second contact portion of the second wiring pattern at the overlapping portion of the first main line portion of the first circuit body and of the second main line portion of the second circuit body. In other words, the first circuit body and the second circuit body are electrically connected to each other. The first branch line portion and the second branch line portion (hereinafter also referred to as “branch lines”) extend to branch from the first main line portion and the second main line portion, respectively. Therefore, when the battery assembly expands and contracts in the stacking direction due to the thermal deformation of each of the single cells, each of the busbars can move in the stacking direction of the single cells by bending the branch line or the like. Similarly, by the bending the branch line or the like, the variation in the size of the battery assembly in the stacking direction due to the assembly tolerance of the single cells can be absorbed. In other words, the busbar module having the present configuration can easily cope with the extension and contraction and the manufacturing variation of the battery assembly by deforming the branch line. Here, in general, even when the flexible substrate includes a large number of circuit structures, the flexible substrate is easily and flexibly deformed with a much smaller force than an electric wire used in the busbar module in the related art described above. Therefore, the ease of assembly into the battery assembly is improved. Accordingly, the busbar module having the present configuration can be easily assembled to the battery assembly and has more excellent adaptability to the deformation and the manufacturing variation of the battery assembly than the busbar module in the related art described above.

According to the busbar module having the above configuration, the first circuit body and the second circuit body are prepared as separate bodies and then electrically connected to each other. Therefore, compared to a case in which the first circuit body and the second circuit body are formed of a single continuous flexible substrate, the length of the first circuit body and the second circuit body in the stacking direction is shortened. Therefore, a dedicated large-sized mounting device is not required when the electronic components are attached (that is, mounted) to the first branch line portion and the second branch line portion. In other words, even when the length or the size of the final main line obtained by connecting the first circuit body and the second circuit body is not suitable for a general (general-purpose) mounting device, the first circuit body and the second circuit body may be connected to each other after the electronic component is appropriately mounted on the branch circuit body using the general (general-purpose) mounting device for each of the first circuit body and the second circuit body. Therefore, the manufacturing cost of the busbar module can be reduced.

According to the busbar module having the above configuration, since the first circuit body and the second circuit body are prepared as separate bodies and then electrically connected to each other, when the busbar module is exposed to water or the like, liquid such as the water may enter the overlapping portion of the first main line portion of the first circuit body and the second main line portion of the second circuit body (between the first main line portion and the second main line portion). However, since the busbar module includes the waterproof portion that seals the overlapping portion in a watertight manner, it is possible to prevent occurrence of a problem in which the adjacent connection portions are conducted (short-circuited) through liquid.

(ii)

In the busbar module (10) according to the above (i),
the waterproof portion is a coating material (32) that is applied to close at least a part of a gap at an edge portion (23a) of the overlapping portion.

According to the busbar module having the configuration of the above (ii), the coating material is applied to close at least a part of the gap at the edge portion of the overlapping portion of the first circuit body and the second circuit body, so that liquid is prevented from entering the gap.

(iii)

In the busbar module (110) according to the above (i),
the waterproof portion is a tape (132) that is attached to an outer surface of the overlapping portion to cover an edge portion (123a) of the overlapping portion.

According to the busbar module having the configuration of the above (iii), the tape is attached to the outer surface of the overlapping portion to cover the edge portion of the overlapping portion of the first circuit body and the second circuit body, so that liquid is prevented from entering the gap in the overlapping portion.

Although the present disclosure has been described in detail with reference to the specific embodiments, it is apparent to those skilled in the art that various changes and modifications can be made without departing from the spirit and scope of the present disclosure.

### INDUSTRIAL APPLICABILITY

According to the present disclosure, it is possible to provide a busbar module that is easy to assemble to a battery assembly and has excellent adaptability to deformation and a manufacturing variation of the battery assembly. The present disclosure having this effect is useful in relation to the busbar module.

What is claimed is:

1. A busbar module to be attached to a battery assembly in which a plurality of single cells are stacked, the busbar module comprising:
a first circuit body that is formed of a flexible substrate having a first wiring pattern and that includes a first main line portion and a first branch line portion, the first main line portion extending along a stacking direction of the plurality of single cells, and the first branch line portion extending to branch from the first main line portion;
a second circuit body that is formed of a flexible substrate having a second wiring pattern and that includes a second main line portion and a second branch line portion, the second main line portion extending along the stacking direction, and the second branch line portion extending to branch from the second main line portion;
busbars each of which is connected to an electrode of the plurality of single cells;
an electronic component that is attached to the first branch line portion and the second branch line portion such that the first wiring pattern and the second wiring pattern are connected to the corresponding busbars; and
a holder that is extensible and contractible along the stacking direction and is configured to hold the first circuit body, the second circuit body, and the busbars,
wherein the first wiring pattern includes a plurality of first contact portions arranged in the stacking direction,
wherein the second wiring pattern includes a plurality of second contact portions arranged in the stacking direction,
wherein the plurality of first contact portions and the plurality of second contact portions are respectively and electrically connected at an overlapping portion of the first main line portion and the second main line portion, and
wherein a waterproof portion that seals the overlapping portion in a watertight manner is further provided.

2. The busbar module according to claim 1,
wherein the waterproof portion is a coating material that is applied to close at least a part of a gap at an edge portion of the overlapping portion.

3. The busbar module according to claim 1,
wherein the waterproof portion is a tape that is attached to an outer surface of the overlapping portion to cover an edge portion of the overlapping portion.
